(19) United States
(12) Patent Application Publication
(10) Pub. No.: US 2024/0227009 A9
(43) Pub. Date: Jul. 11, 2024

(54) ALLOYING VIA ULTRASONIC ATOMIZATION

(71) Applicant: Divergent Technologies, Inc., Los Angeles, CA (US)

(72) Inventors: Chan Cheong PUN, Costa Mesa, CA (US); Mu Li, San Pedro, CA (US)

(21) Appl. No.: 18/491,628

(22) Filed: Oct. 20, 2023

Related U.S. Application Data
(60) Provisional application No. 63/417,929, filed on Oct. 20, 2022.

(51) Int. Cl. B22F 9/08; B22F 1/17; B33Y 70/10

(52) U.S. Cl. CPC B22F 9/082; B22F 1/17; B33Y 70/10

(57) ABSTRACT

A method and an apparatus for forming powder. The formed powder may include an alloy of powder that can be used in additively manufacturing and powder metallurgy applications to create structures. The method and apparatus may deliver a source material having a first material composition, melt the source material to form a molten source material, vibrate a substate structure, the substrate structure including a substrate material having a substrate material composition, apply the molten source material to the vibrating substrate structure to obtain a powder, where a portion of the substrate material is selectively added to the molten source material such that the powder has a second material composition different than the first material composition, and control the second material composition of the powder based on the first material composition and the substrate material composition.

### CROSS-REFERENCE TO RELATED APPLICATION

This application claims the benefit of U.S. Provisional Application No. 63/417,929 filed on Oct. 20, 2022, entitled “In-Situ Alloying via Sonotrode Atomization”, the entirety of which is incorporated by reference as if fully set forth herein.

### BACKGROUND

### Field

The present disclosure relates generally to the production of powder, and more specifically, an alloy powder is produced using ultrasonic atomization and may be used in additive manufacturing and powder metallurgy applications to create structures.

### Background

Various manufacturing processes use powdered material as feedstock to produce structures. For example, some three-dimensional (3-D) printers, such as powder bed fusion (PBF) printers, binder jet printers, etc., use powder feedstock. In these manufacturing processes, the composition of the powder can be important to ensure the manufactured structures possess desired features in order to properly function and perform their intended use.

Powder may be expensive and difficult or impossible to make using some known conventional methods, and thus it may be impossible or expensive to manufacture a structure to perform certain functions or purposes. For example, currently many powder manufactures cannot or are unwilling to make some metal powders because the profit margin is undesirable, e.g., some elemental components of the metal powder, such as zirconium, tend to react favorably with oxygen creating slag that contaminates the overall alloy composition of the metal powder, resulting in low yield. In some cases, powder manufactures are unwilling to make some metal powders because of safety concerns, e.g., some elemental components of the metal powder, such as lithium, possess a high risk of starting a H₂ (hydrogen gas) fire. Also, conventional methods of gas and plasma atomization may not be able to produce a metal powder containing some elemental components because of the physics of gas and plasma atomization. Some conventional methods of gas and plasma atomization melt all materials that will form the metal powder, and if an elemental material has a lower vaporization pressure or temperature than the metal element comprising, for example, the largest weight percentage of the metal powder, then this elemental material having the lower vaporization pressure or temperature will evaporate and be carried away before the melting of this largest weight percentage metal element and therefore cannot be present in the final metal powder product. Additionally, obtaining some characteristics of the powder may not be possible using some known methods. For example, the methods of gas and plasma atomization cannot produce metal powder with a consistent spherical shape and a narrow particle size distribution.

### SUMMARY

In various example embodiments using ultrasonic atomization, any powder composition may be produced and the produced powder can possess near-perfect spheroidicity (>99%) of particles, narrow particle size distribution, and lacks small/fine satellites. Satellites are small particles that stick to a larger particle, thus forming an undesired particle defect. For example, a satellite may include a small particle attached to a surface of a larger particle and the smaller particle being 1%-20% of a diameter of the larger particle. In various embodiments, various advantages may be realized as described in more detail below for various embodiments. For example, benefits may include flexibility of producing powder that may be customized to meet an individual part's design, application and physical property requirements, and to maximize performance and weight-savings of a part. Several aspects of the apparatuses and methods of making the powder will be disclosed more fully hereinafter. The following summary of the one or more aspects of the disclosure are in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In various example embodiments disclosed herein are apparatuses and methods of forming powder. In one aspect, the method for creating powder includes delivering a source material having a first material composition; melting the source material to form a molten source material; vibrating a substate structure, the substrate structure includes a substrate material having a substrate material composition; applying the molten source material to the vibrating substrate structure to obtain a powder, a portion of the substrate material is selectively added to the molten source material such that the powder has a second material composition different than the first material composition; and controlling the second material composition of the powder based on the first material composition and the substrate material composition.

In one or more embodiments, the method of controlling the second material composition is further based on a grain structure of the substrate material.

In one or more embodiments, the method of controlling the second material composition is further based on at least a delivery parameter of delivering the source material, a melt parameter of melting the source material, a vibration parameter of vibrating the substrate structure, or an application parameter of applying the molten source material.

In one or more embodiments, the delivery parameter includes at least a feed rate of the source material or a feed angle of the source material.

In one or more embodiments, the source material is in the form of a wire or a rod, and the delivery parameter includes at least the feed rate of the wire or the rod or the feed angle of the wire or the rod.

In one or more embodiments, the method of melting is performed by an energy beam or a plasma, and the melt parameter includes an energy of the energy beam or a temperature of the plasma.

In one or more embodiments, the vibration parameter includes at least an area of a vibrating surface of the substrate structure, a surface energy density of the substrate structure, a frequency of the vibrating, an amplitude of the vibrating, or a speed of the vibrating.

In one or more embodiments, the application parameter includes at least a density of the molten source material, a liquid velocity of the molten source material, a liquid flow rate of the molten source material, a liquid viscosity of the molten source material, or a surface tension of the molten source material.

In one or more embodiments, the second material composition includes the portion of the substrate material as a coating outside the powder.

In one or more embodiments, the second material composition includes the portion of the substrate material as a solute inside the powder.

In one or more embodiments, the first material composition includes a first element, and a composition of the substrate material includes the first element and a second element.

In one or more embodiments, the method of controlling the second material composition is further based on a ratio of the second element to the first element in the composition of the substrate.

In one or more embodiments, the substrate material composition includes at least lithium, zinc, silver or magnesium.

In one or more embodiments, the substrate material composition includes aluminum.

In one or more embodiments, the substrate material composition further includes at least one of lithium, zinc, silver or magnesium.

In one or more embodiments, the first material composition includes at least copper and zirconium.

In one or more embodiments, the method further includes forming a base material on a bottom surface of the substrate structure.

In one or more embodiments, the base material includes a material configured to dissipate heat generated by the molten source material.

In one or more embodiments, the base material includes copper.

In one or more embodiments, an apparatus for making powder includes a substrate structure including a substate material having a substrate material composition; a vibrating device configured to vibrate the substrate structure; a heating device configured to melt a source material having a first material composition, the source material forms a molten source material that is applied to the vibrating substrate structure to obtain a powder, a portion of the substrate material is selectively added to the molten source material such that the powder has a second material composition different than the first material composition, and the second material composition is controlled based on the first material composition and the substrate material composition; and a delivering device configured to deliver the source material to the heating device.

In one or more embodiments, the second material composition is further controlled based on a grain structure of the substrate material.

In one or more embodiments, the apparatus further includes a controller configured to control the second material composition further based on at least a delivery parameter of delivering device, a melt parameter of heating device, a vibration parameter of vibrating device, or an application parameter of the application of the molten source material to the vibrating substrate structure.

In one or more embodiments, the delivery parameter includes at least a feed rate of the source material or a feed angle of the source material.

In one or more embodiments, the source material is in the form of a wire or a rod, and the delivery parameter includes at least the feed rate of the wire or the rod or the feed angle of the wire or the rod.

In one or more embodiments, the heating device is an energy beam or a plasma, and the melt parameter includes an energy of the energy beam or a temperature of the plasma.

In one or more embodiments, the vibration parameter includes at least an area of a vibrating surface of the substrate structure, a surface energy density of the substrate structure, a frequency of the vibrating, an amplitude of the vibrating, or a speed of the vibrating.

In one or more embodiments, the application parameter includes at least a density of the molten source material, a liquid velocity of the molten source material, a liquid flow rate of the molten source material, a liquid viscosity of the molten source material, or a surface tension of the molten source material.

In one or more embodiments, the second material composition includes the portion of the substrate material as a coating outside the powder.

In one or more embodiments, the second material composition includes the portion of the substrate material as a solute inside the powder.

In one or more embodiments, the first material composition includes a first element, and a composition of the substrate material includes the first element and a second element.

In one or more embodiments, the controller configured to control the second material composition is further based on a ratio of the second element to the first element in the composition of the substrate.

In one or more embodiments, the substrate material composition includes at least lithium, zinc, silver or magnesium.

In one or more embodiments, the substrate material composition includes aluminum.

In one or more embodiments, the substrate material composition further includes at least lithium, zinc, silver or magnesium.

In one or more embodiments, the first material composition includes at least copper or zirconium.

In one or more embodiments, the apparatus further includes a base material on a bottom surface of the substrate structure.

In one or more embodiments, the base material includes a material configured to dissipate heat generated by the molten source material.

In one or more embodiments, the base material includes copper.

Other aspects will become readily apparent to those skilled in the art from the following detailed description, wherein is shown and described only several example embodiments by way of illustration. As will be realized by those skilled in the art, concepts described herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of the technology will be presented in the detailed description by way of example, and not by way of limitation, in the appended claims and in the accompanying drawings. In the descriptions that follow, like parts are marked throughout the specification and drawings with the same numerals, respectively. The drawing figures are not necessarily drawn to scale and certain figures can be shown in exaggerated or generalized form in the interest of clarity and conciseness.

FIGS. 1A-1D illustrate respective side views of an example Powder Bed Fusion (PBF) system usable with aspects of the disclosure during different stages of operation according to aspects of the disclosure.

FIG. 1E illustrates a functional block diagram of a PBF system in accordance with an aspect of the present disclosure.

FIG. 2 illustrates an example of an apparatus for making powder.

FIG. 3 illustrates an example of the powder including an outer coating of material and material on the inside surface of the powder.

FIG. 4 illustrates a method for making powder.

### DETAILED DESCRIPTION

To overcome the above problems associated with making powder there is a need to develop a method and apparatus to produce powder that includes a wider range of compositions, near-perfect circularity (>99%) of particles, narrow particle size distribution, desired characteristics, and lack of small/fine satellites. The disclosed methods and apparatuses within the various example embodiments may enable creation of alloy compositions that are not possible in conventional gas or plasma atomization methods.

In various example embodiments, a wider range of compositions of powder is produced by the disclosed apparatuses and methods because a portion of a substrate material is selectively added to a molten source material without the need to be heated with the source material and therefore elemental elements/material in the substrate material may not vaporize and be removed before bonding with the molten source material.

In various example embodiments, ultrasonic atomization may be used in the disclosed apparatuses and methods to produce the powder. The powder may be used in additive manufacturing (AM) and powder metallurgy applications. For example, the powder may be metal powder used in three-dimensional (3-D) systems and printers to form/print structures that are used with, installed on or form part of a vehicle. The vehicle may include cars, trucks, vans, buses, snowmobiles, boats, ships, aircraft, jets, gliders, and other type of land, air and sea vehicles. Also, the powder may be used in powder metallurgy applications of casting and forging of parts. The powder may include an alloy powder and non-metal powder.

An apparatus for making powder includes a substate material having a substrate material composition; a vibrating device configured to vibrate the substrate structure; a heating device configured to melt a source material having a first material composition, the source material forms a molten source material that is applied to the vibrating substrate structure to obtain a powder, a portion of the substrate material is selectively added to the molten source material such that the powder has a second material composition different than the first material composition, and the second material composition is controlled based on the first material composition and the substrate material composition; and a delivering device configured to deliver the source material to the heating device.

A method for creating powder, the method includes delivering a source material having a first material composition; melting the source material to form a molten source material; vibrating a substate structure, the substrate structure includes a substrate material having a substrate material composition; applying the molten source material to the vibrating substrate structure to obtain a powder, a portion of the substrate material is selectively added to the molten source material such that the powder has a second material composition different than the first material composition; and controlling the second material composition of the powder based on the first material composition and the substrate material composition.

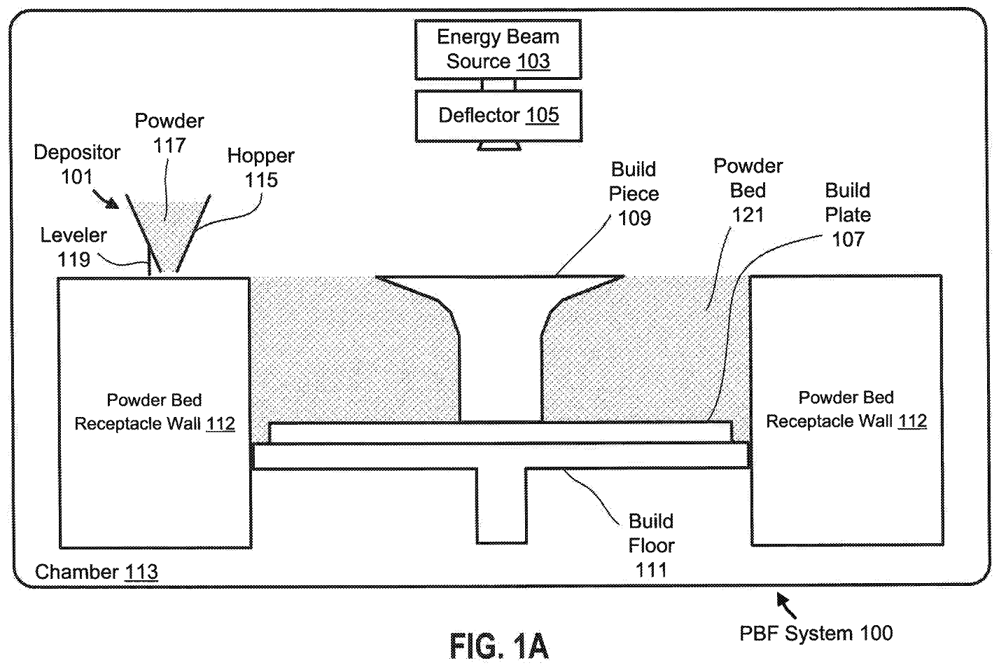

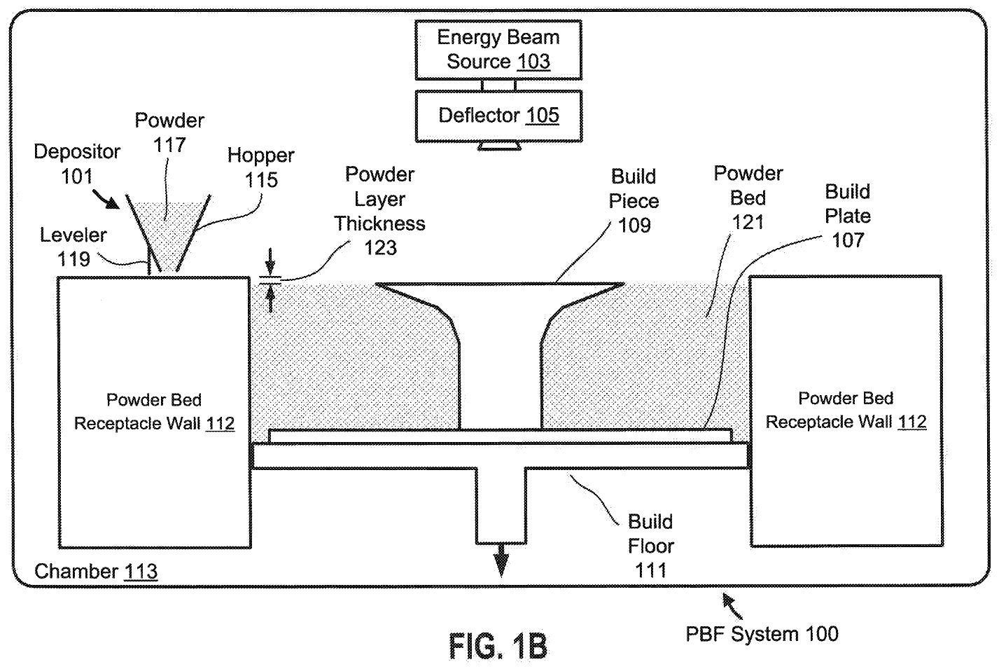

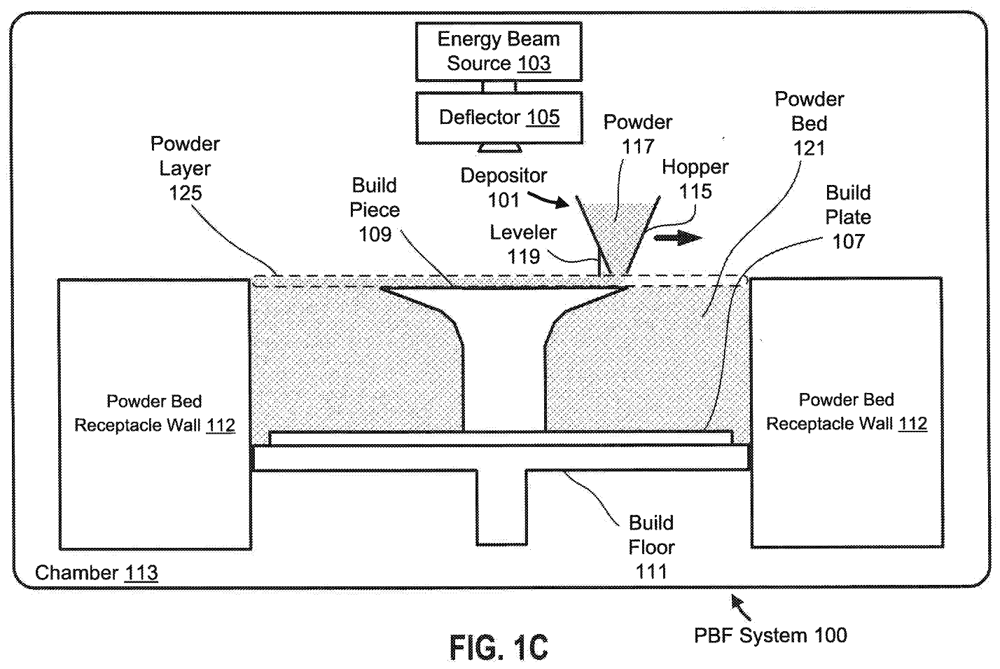

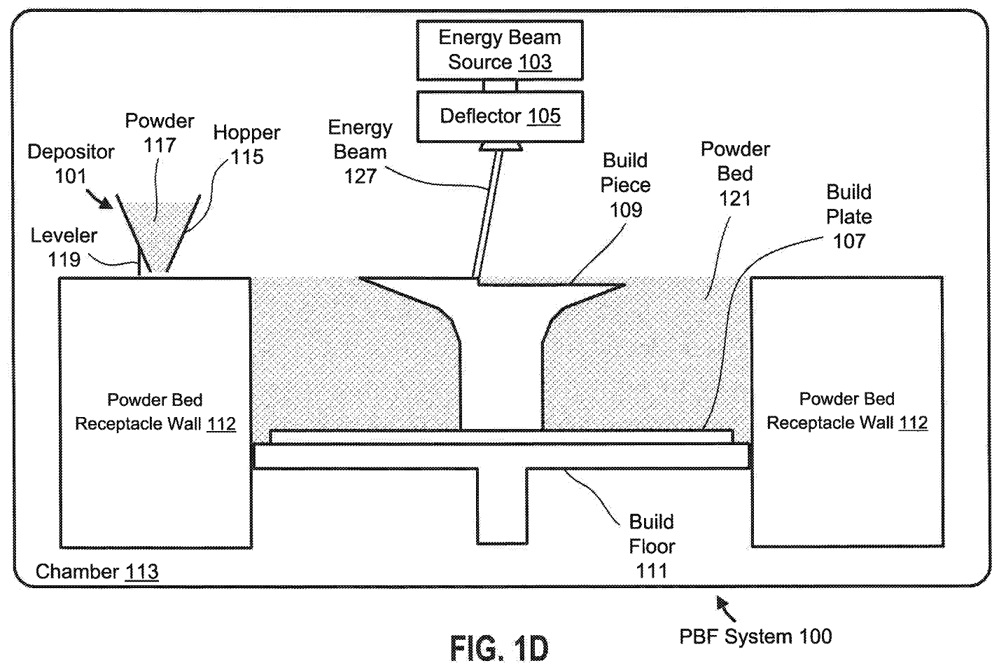

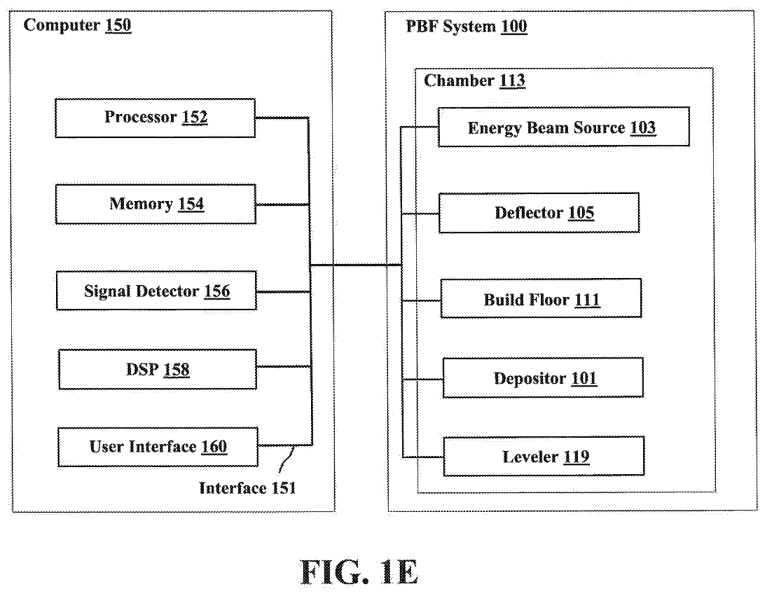

FIGS. 1A-1D illustrate respective side views of an example of a PBF system 100 usable with aspects of the disclosure including a 3-D printer during different stages of operation. As noted above, the particular embodiment illustrated in FIGS. 1A-1D is one of many suitable examples of a PBF system employing principles of this disclosure. It should also be noted that elements of FIGS. 1A-1D and the other figures in this disclosure are simplified and not necessarily drawn to scale, but may be drawn larger or smaller and/or with reduced detail for the purpose of better illustration of concepts described herein. PBF system 100 can include depositor 101 that can deposit each powder layer 125, energy beam source 103 that can generate energy beam 127, deflector 105 that can direct or redirect the energy beam to melt powder 117, and build plate 107 that can support one or more build pieces, such as build piece 109. PBF system 100 can also include build floor 111 positioned within a powder bed receptacle and between powder bed receptacle walls 112. Build floor 111 can progressively lower build plate 107 so that depositor 101 can deposit a next layer. In some examples, all of the above disclosed features of the PBF system may reside in chamber 113 to enclose these features, thereby protecting these features from atmospheric conditions (e.g., providing the features in an inert environment) and temperature regulation and mitigating contamination risks. Depositor 101 can include hopper 115 that contains powder 117, such as a metal (e.g., alloy) or non-metal (e.g., plastic or thermoplastic polymer) powder, and leveler 119 that can level the top of each layer of deposited powder.

Referring specifically to FIG. 1A, this figure shows PBF system 100 after a slice of build piece 109 has been fused by energy beam 127, but before the next layer of powder has been deposited. In fact, FIG. 1A illustrates a time at which PBF system 100 has already deposited and fused a partially completed build piece in multiple layers to form the current state of build piece 109. The multiple layers already deposited have created powder bed 121, which includes powder that was deposited but not melted.

FIG. 1B shows PBF system 100 at a stage in which build floor 111 can lower by powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 moves over the defined space while releasing powder 117 from hopper 115. Leveler 119 can level the released powder to form powder layer 125 that has a thickness substantially equal to powder layer thickness 123 (see FIG. 1B). Thus, the powder in a PBF system can be supported by a powder material support structure, which can include, for example, build plate 107, build floor 111, build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates energy beam 127 and deflector 105 applies the energy beam to melt the next slice in build piece 109. In various example embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be melted. In various embodiments, energy beam source 103 can be a laser beam source, in which case energy beam 127 is a laser beam. Deflector 105 may include an optical system that uses reflection and/or refraction to manipulate the laser beam to scan selected areas/regions on the powder layer to be melted. In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas/regions of the powder layer. For example, in various aspects of the disclosure, the energy beam can be modulated by a digital signal processor (DSP). The deflector may include any known system in the art, for example a galvo-scanner or galvanometer, and/or a raster scanner. It is noted that while a single energy beam source 103 and/or deflector 105 is shown, aspects of the disclosure are usable with and may include a system with multiple energy source(s) and/or deflector(s).

As shown in FIG. 1D, much of the melting of powder layer 125 occurs in areas/regions of the powder layer that are on top of the previous slice, i.e., previously-melted powder. An example of such an area is the surface of build piece 109. The melting of the powder layer in FIG. 1D is occurring over the previously fused layers characterizing the substance of build piece 109. However, in some areas of powder layer 125, melting can occur on top of loose powder namely, over powder that was not fused inadvertently or otherwise. For example, if the slice area is bigger than the previous slice area, at least some of the slice area will be formed over loose powder. Applying the energy beam to melt an area of powder over loose powder can be problematic. Melted powder is liquefied and generally denser than loose powder. The melted powder can seep down into the loose powder causing drooping, curling, or other unwanted deformations in build piece 109. Because loose powder can have low thermal conductivity, higher temperatures than expected can result when melting powder in overhang areas because the low thermal conductivity can reduce the ability for heat energy to conduct away from fused powder. Higher temperatures in these areas result in higher residual stresses after cooling and, more often than not, a poor-quality build piece. In some cases, dross formations can occur in overhang areas thereby resulting in undesired surface roughness or other quality problems.

FIG. 1E illustrates a functional block diagram in accordance with an aspect of the present disclosure and useable with disclosed 3-D printer, and PBF systems and apparatuses. In an aspect of the present disclosure, control devices and/or elements, including computer software, may be coupled to PBF system 100 to control one or more components or process parameters within PBF system 100. Such a device may be a computer 150, which may include one or more process parameters 260 that may assist in the control of PBF system 100. Computer 150 may communicate with PBF system 100, and/or other AM systems, via one or more interfaces 151 (e.g., a bus system). Controller 250, computer 150 and/or interface 151 are examples of devices that may be configured to implement the various systems, apparatuses and methods described herein, that may assist in controlling PBF system 100 and/or other AM systems. Interface 151 may comprise an input/output device that allows controller 250 and/or computer 150 to exchange information with other devices. In some implementations, interface 151 may include one or more of a parallel port, a serial port, or other computer interfaces.

In an aspect of the present disclosure, computer 150 may include at least one processor 152, memory 154, signal detector 156, digital signal processor (DSP) 158, and one or more user interfaces 160. Computer 150 may include additional components without departing from the scope of the present disclosure.

Computer 150 may include at least one processor 152, which may assist in the control, processing and/or operation of PBF system 100. The processor 152 may also be referred to as a central processing unit (CPU). Memory 154, which may include both read-only memory (ROM) and random-access memory (RAM), may provide instructions and/or data to processor 152. A portion of memory 154 may also include non-volatile random-access memory (NVRAM). Processor 152 typically performs logical and arithmetic operations based on program instructions stored within memory 154. The instructions in memory 154 may be executable (e.g., by processor 152) to implement the functions and methods described herein.

Processor 152 may include or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

Processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Computer 150 may also include signal detector 156 that may be used to detect and quantify any level of signals received by computer 150 for use by processor 152 and/or other components of computer 150. Signal detector 156 may detect such signals energy beam source 103 power, deflector 105 position, build floor 111 height, amount of powder 117 remaining in depositor 101, leveler 119 position, and other signals. Signal detector 156, in addition to or instead of processor 152 may also control other components as described with respect to the present disclosure. Computer 150 may also include DSP 158 for use in processing signals received by computer 150 or processor 162. The DSP may be configured to generate instructions and/or packets of instructions for transmission to PBF system 100.

Computer 150 may further comprise user interface 160 in some aspects. User interface 160 may comprise a keypad, a pointing device, and/or a display. User interface 160 may include any element or component that conveys information to a user of computer 150 and/or receives input from the user.

The various components of computer 150 may be coupled together by bus system 151. Bus system 151 may include a data bus, for example, as well as a power bus, a control signal bus, and a status signal bus in addition to the data bus. Components of computer 150 may be coupled together or accept or provide inputs to each other using some other mechanism.

Although a number of separate components are illustrated in FIG. 1E, one or more of the components may be combined or commonly implemented. For example, processor 152 may be used to implement not only the functionality described above with respect to processor 152, but also to implement the functionality described above with respect to signal detector 156, DSP 158, and/or user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by computer 150. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by computer 150. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media). The RAM may include one or more Static Random Access Memory (SRAM), Dynamic Random Access Memory (DRAM), Synchronous Dynamic Random Access Memory (SDRAM), Double Data-Rate Random Access Memory (DDR SDRAM), or other suitable volatile memory. The Read-only Memory (ROM) may include one or more Programmable Read-only Memory (PROM), Erasable Programmable Read-only Memory (EPROM), Electronically Erasable Programmable Read-only memory (EEPROM), flash memory, or other types of non-volatile memory.

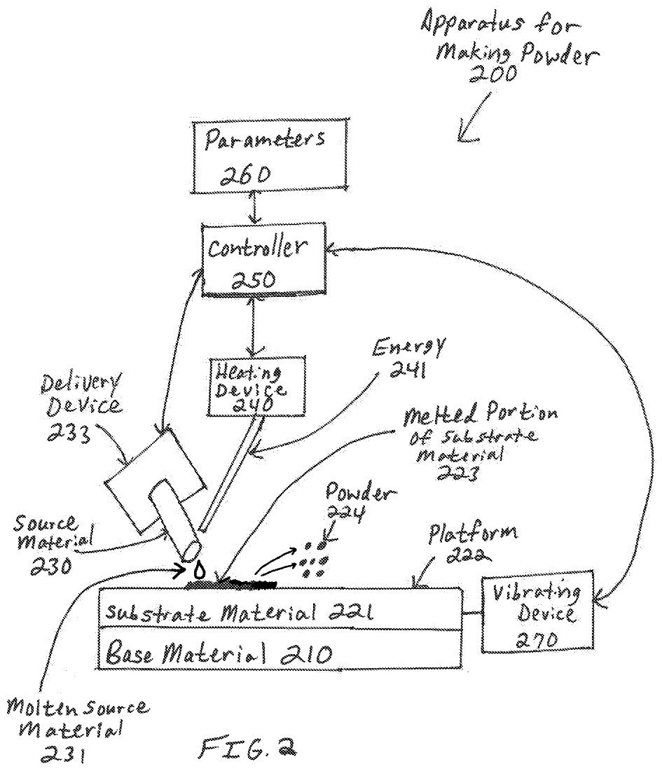

FIG. 2 illustrates an example apparatus 200 for making powder. In some embodiments, the powder made by apparatus 200 may be supplied to and used in PBF system 100. Also, parameter(s) 260 of apparatus 200 may also include the disclosed parameter(s) in PBF system 100 and controller 250 may perform the disclosed functions and in communication with the computer, processor(s) and parameters of PBF system 100.

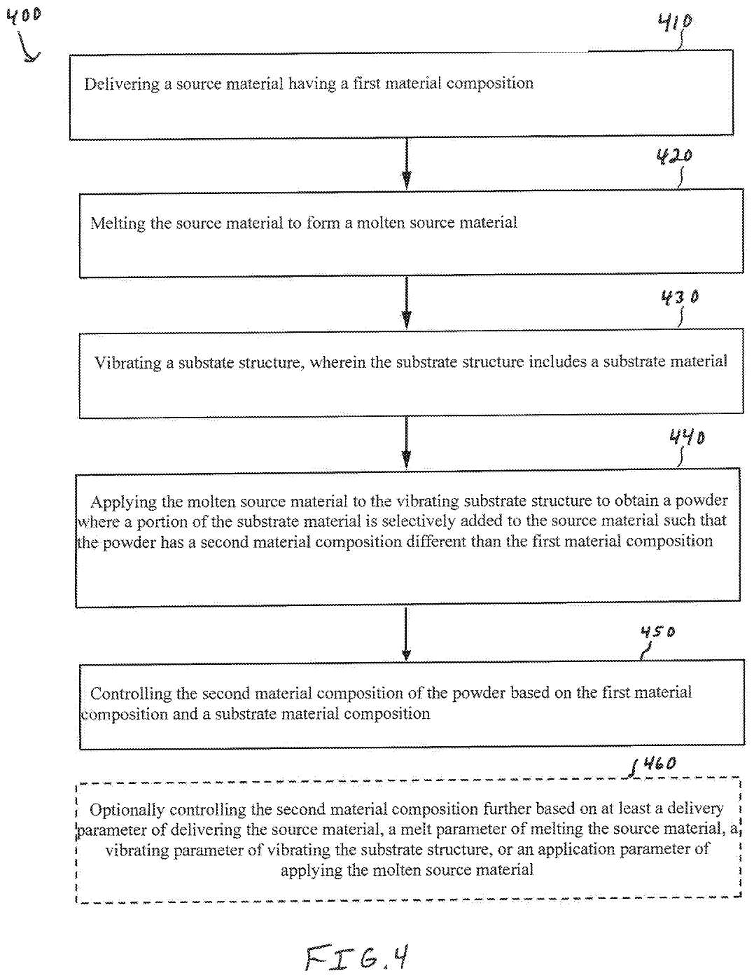

FIG. 2 illustrates an example embodiment of a source material 230, a delivery device 233, a heating device 240, a substrate structure 220, a vibrating device 270, a controller 250 and parameters 260. Delivery device 233 is configured to deliver source material 230 to heating device 240. The heating device is configured to heat and melt the source material to form a molten source material 231 and allow the molten source material to contact a substrate material 221 of the substrate structure. The molten source material is at a temperature such that when the molten source material contacts an area/portion of a surface or platform 222 of the substrate structure, a portion of substrate material 221 is added to the molten source material in this contact area of the substrate structure. The resulting material composition (i.e., the molten source material and the added portion of the substrate material) can be controlled based on the selection of the material composition of the source material and the material composition of the substrate material. The vibrating device generates vibrations 271 (See FIG. 4) in the area of the surface of the substrate structure to form a powder 224 from the molten source material and added substrate material. The vibrations are configured to eject the molten source material with added substrate material from the area/portion of the substrate structure's surface and this ejected material forms the powder.

Source material 230 may be a composition of elements, an alloy, an aluminum alloy, or a non-metallic material. The source material may be in the form of a wire, a bar or in any geometric shape. The source material may include aluminum (Al), lithium (Li), copper (Cu), magnesium (Mg), silver (Ag), zinc (Zn) or zirconium (Zr) or a combination of one or more of aluminum (Al), lithium (Li), copper (Cu), magnesium (Mg), silver (Ag), zinc (Zn) and zirconium (Zr).

Heating device 240 is configured to melt source material 230. The heating device may be in direct contact or indirect contact with the source material. The heating device may include an electrode transferring energy 241 to the source material by electricity, plasma, energy beam (such as a laser), thermal energy or other forms of energy. For example, the electrode may include tungsten. The energy may be in the form of an arc. The heating device may be an energy beam source that generates an energy beam. For example, the energy beam source may be a laser beam source that generates a laser beam.

Heating device 240 may melt of source material 230 in a controlled environment in order to prevent atmospheric conditions from contaminating powder 224. The controlled environment may include a vacuum environment or an inert environment. The inert environment may include a gas environment, where the gas may include helium, nitrogen, argon or other inert gases.

Substrate structure 220 includes platform 222 for molten source material 231 to interact therewith. The substrate structure includes substrate material 221. The interaction of the molten source material with the substrate material includes a portion of the substrate material being added to the molten source material and the molten source material contacting and melting a portion of the substrate material creating an alloying effect. (i.e., mixing of the source material and the substrate material) For example, due to the high temperature of the molten source material, when the molten source material contacts the substrate material a portion of the substrate material is added to the molten source material. In various embodiments, the substrate material may be controlled to become a solute inside the powder. In various embodiments, the substrate material may be controlled to become a coating outside the powder. The substrate material may be a composition of elements, an alloy, an aluminum alloy, or a non-metallic material. The substrate material may include aluminum (Al), lithium (Li), copper (Cu), magnesium (Mg), silver (Ag), zinc (Zn) or zirconium (Zr) or a combination of one or more of aluminum (Al), lithium (Li), copper (Cu), magnesium (Mg), silver (Ag), zinc (Zn) and zirconium (Zr). In various embodiments, the material composition of the source material may include a first element (e.g., aluminum), and the substrate material can include the first element and a second element (e.g., aluminum and lithium). In various embodiments, the material composition of the powder may be controlled by selecting the ratio of the second element to the first element in the substrate material composition. Selecting a higher ratio may add more of the second element to the source material composition. For example, a pure aluminum source material may be used, and a ratio of lithium to aluminum in the substrate material may be selected to be 1/10(i.e., 10% lithium). This ratio may result in a powder with a lithium content of 3% by weight (with balance being aluminum). However, selecting a ratio of ⅓(i.e., 30% lithium) may result in a powder with a lithium content of 7% (with balance being aluminum).

In various embodiments, a grain structure of the substrate material may be selected to control the material composition of the powder. For example, using a substrate material with a small grain size may increase the amount of substrate material added to the molten substrate material. In various embodiments, other structural characteristics of the grains may be used to add more or less of the substrate material to the molten source material.

Vibrating device 270 is configured to produce vibrations 271 in substrate structure 220. The vibrations initiate atomization, which is forming vibrations on the substrate structure such that the vibrations eject material (i.e., the molten source material and added substrate material) from the surface of the substrate structure. When the platform or an area of a surface of the substrate material is vibrated, the bonded substrate material and molten metal will be ejected from a surface of the substrate structure creating the powder from (i.e., out of) the (alloyed) composition of the source material and the substrate material.

The atomization may include ultrasonic atomization. Ultrasonic atomization includes atomization, as disclosed above, such that the vibrations are soundwaves and the vibrations have frequencies above a human ear's audibility limit. For example, ultrasonic atomization includes atomization such that the vibrations include frequencies greater than about 20,000 hertz. In various embodiments, vibrations may be lower than 20,000 hertz.

The amplitude of the vibrations needs to exceed a certain threshold value to initiate the atomization. In various embodiments, the amplitude threshold value may be calculated from equation,

$${A}_{m} = \frac{2 μ}{ρ} \sqrt[3]{\frac{ρ}{πσ f}} ,$$

where Aₘ is a threshold value of the vibration amplitude [μm], μ is dynamic viscosity [Pa*s] of a material (e.g., substrate material 221), ρ is liquid density [kg/m³] of a material (e.g., bonded melted source material 231 and substrate material 221), σ is surface tension [N/m] and ƒ is vibration frequency [Hz]. The vibrating device may include a transducer, an ultrasonic transducer, an electromechanical transducer, etc. The transducer may be a piezoelectric transducer, a Langevin transducer, etc.

Apparatus 200 may include a base material 210. The base may be coupled to a bottom surface of substate material 221. The base material may include a material configured to dissipate heat generated by the molten source material and the vibrations. The base material is thermally conductive to transfer heat away from the substrate structure. The base material may include copper, diamond, silver, tungsten, graphite, or nickel. The base material may be the same material as the substrate material or a different material than the substrate material. The base substate material and the substrate material may be two separate pieces and when coupled together the separate pieces form the substrate structure. However, the substrate structure may include a single unitary piece including the base material and the substate material

Apparatus 200 may include controller 250. The controller is coupled to and in communication with delivery device 233, heating device 240, parameter(s) 260 and vibrating device 270 in order to be configured to control and/or the delivery device, the heating device and the vibrating device based on one or more of parameters 260 to control the material composition of the powder. For example, delivery parameters of the delivery device may include a feed rate of the source material (such as a feed rate of a wire or rod of the source material) or a feed angle of the source material (such as a feed angle of a wire or rod of the source material). Melt parameters of the heating device may include, for example, an energy of an energy beam or a temperature of a plasma, etc. Vibration parameters of the vibrating device may include, for example, an area of a vibrating surface of the substrate structure, a surface energy density of the substrate structure, a frequency of the vibrating, an amplitude of the vibrating, or a speed of the vibrating. In various embodiments, parameters may include application parameters that are related to how the melted source material is applied to the substrate structure. For example, application parameters may include a density of the molten source material, a liquid velocity of the molten source material, a liquid flow rate of the molten source material, a liquid viscosity of the molten source material, or a surface tension of the molten source material.

Controller 250 may be configured to control the various devices in apparatus 200 based on one or more parameters 260 to obtain an alloy composition of the powder. For example, the controller can control apparatus 200 to form a coating of the substrate material on an outer surface of the powder and/or to form a solute of the substrate material on an inside surface of the powder. The coating may include copper. For example, the controller may be configured to control the parameters of a feed rate of the source material and/or a feed angle at which the source material is fed into the heating device. The controller may also be configured to control, based on the parameters, a temperature of the energy generated by the heating device, the angle the energy, from the heating device, is directed toward the source material and the substrate structure, and the location/area of the source material and the substrate structure the energy is directed toward. The controller may also be configured to control, based on the parameters, a frequency and an amplitude of the vibrations generated by the vibrating device.

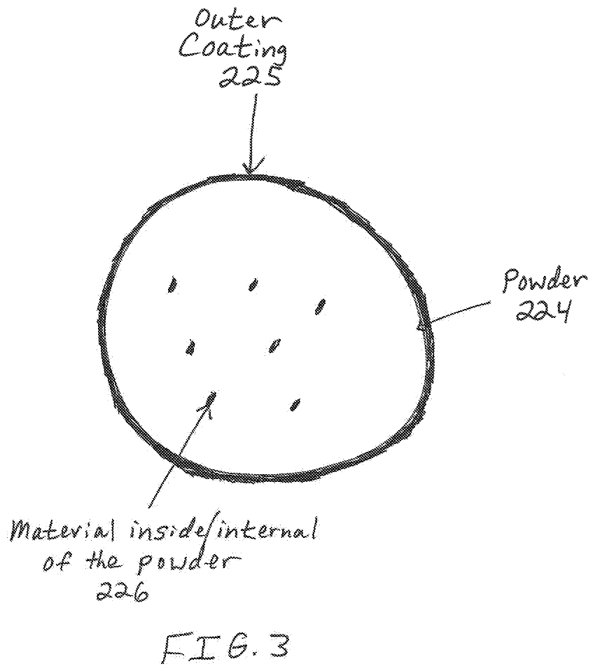

FIG. 3 illustrates an example of the powder including an outer coating of the substrate material and a solute of the substrate material inside the powder. For example, powder 224 includes an outer coating 225 of substrate material and a solute of the substrate material on the inside 226 of the powder. The outer coating and the solute material may be the same material or different materials. For example, the outer coating may be copper and the solute may be lithium. As disclosed above, the controller controls the apparatus based on parameters in order to form the outer coatings and solutes of the powder in order to make an alloy composition of powder with desired properties.

Referring to FIG. 4, a flow chart illustrates an example method 400 of making powder. Method 400 may be performed in connection with apparatus 200. Method 400 may include delivering a source material having a first material composition 410, melting the source material to form a molten source material 420, vibrating a substate structure, the substrate structure including a substrate material having a substrate material composition 430, applying the molten source material to the vibrating substrate structure to obtain a powder 440, where a portion of the substrate material is selectively added to the molten source material such that the powder has a second material composition different than the first material composition, and controlling the second material composition of the powder based on the first material composition and the substrate material composition 450. In various embodiments, controlling the second material composition may be further based on a grain structure of the substrate material, as described above.

Method 400 may optionally include controlling (460) the second material composition further based on at least a delivery parameter of delivering the source material, a melt parameter of melting the source material, a vibration parameter of vibrating the substrate structure, or an application parameter of applying the molten source material. In various embodiments, the delivery parameter may include at least a feed rate of the source material or a feed angle of the source material. For example, the source material may be in the form of a wire or a rod, and the delivery parameter may include the feed rate of the wire or the rod or the feed angle of the wire or the rod. In various embodiments, the melting may be performed by an energy beam or a plasma, and the melt parameter may include an energy of the energy beam or a temperature of the plasma. In various embodiments, the vibration parameter may include an area of a vibrating surface of the substrate structure, a surface energy density of the substrate structure, a frequency of the vibrating, an amplitude of the vibrating, or a speed of the vibrating. In various embodiments, the application parameter may include a density of the molten source material, a liquid velocity of the molten source material, a liquid flow rate of the molten source material, a liquid viscosity of the molten source material, or a surface tension of the molten source material.

In various embodiments, the second material composition may include the portion of the substrate material as a coating outside the powder. In various embodiments, the second material composition may include the portion of the substrate material as a solute inside the powder. In various embodiments, the first material composition includes a first element, and a composition of the substrate material includes the first element and a second element. In various embodiments, controlling the second material composition may be further based on a ratio of the second element to the first element in the composition of the substrate. In various embodiments, the substrate material composition may include lithium, zinc, or magnesium. In various embodiments, the substrate material composition may include aluminum. In various embodiments, the substrate material composition may further include lithium, zinc, or magnesium. In various embodiments, the first material composition may include copper or zirconium. In various embodiments, method 400 may further include forming a base material on a bottom surface of the substrate structure. In various embodiments, the base material may include a material configured to dissipate heat generated by the molten source material. In various embodiments, the base material may include copper.

In some implementations, as part of or incorporating various features and methods described herein, one or more microcontrollers may be implemented for controlling any one or combination of the operations described herein (e.g., the operations of the apparatus for making powder 200 described herein). Controller 250 includes a CPU, RAM, ROM, a clock and timer, a BUS controller, an interface, and an analog-to-digital converter (ADC) interconnected via a BUS. The CPU may be implemented as one or more single core or multi-core processors, and receive signals from an interrupt controller and a clock. The clock may set the operating frequency of the entire microcontroller and may include one or more crystal oscillators having predetermined frequencies. Alternatively, the clock may receive an external clock signal.

It is noted that the aforementioned operations are provided as examples. While some specific examples are given, one having ordinary skill in the art would understand that additional possibilities of automated, semi-automated, or manual control of the systems and devices of the disclosed support system formation and removal methods and apparatuses described herein would fall within the scope of this disclosure after understanding the disclosure provided herein.

In addition, aspects of the present disclosures may be implemented using hardware, software, or a combination thereof and may be implemented in one or more computers or computer systems, processors or other processing systems. In an aspect of the present disclosures, features are directed toward one or more computers, processors or computer systems capable of carrying out the functionality described herein.

Computer programs (also referred to as computer control logic) may be stored in a memory in controller 250 and/or secondary memory. Such computer programs, when executed, enable the apparatus for making powder 200 to perform the features in accordance with aspects of the present disclosures, as discussed herein. In particular, the computer programs, when executed, enable controller 250 to perform the features in accordance with aspects of the present disclosures.

In an aspect of the present disclosures where the method is implemented using software, the software may be stored in a computer program product and loaded into a computer 150 using a removable storage drive, a hard drive, or interface(s). The control logic (software), when executed by a processor, causes the processor to perform the functions described herein.

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or sub-combinations in one or more embodiments or examples.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms source, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of source, second, third, and/or fourth may be applied to the components merely as a matter of convenience in the description.

The terms powder bed fusion (PBF) is used throughout the disclosure. PBF systems may encompass a wide variety of additive manufacturing (AM) techniques, systems, and methods. Thus, the PBF system or process as referenced in the disclosure may include, among others, the following printing techniques: direct metal laser sintering (DMLS), electron beam melting (EBM), selective heat sintering (SHS), selective laser melting (SLM) and selective laser sintering (SLS). Still other PBF processes to which the principles of this disclosure are pertinent include those that are currently contemplated or under commercial development. The aspects of the disclosure may additionally be relevant to non-metal additive manufacturing and or metal/adhesive additive manufacturing (e.g., binder jetting), which may forgo an energy beam source and instead apply an adhesive or other bonding agent to form each layer. In the case of binder jetting, the cured or green form may be sintered or fused in a furnace and/or be infiltrated with bronze or other alloys.

The detailed description set forth above in connection with the appended drawings is intended to provide a description of various example embodiments of the concepts disclosed herein and is not intended to represent the only embodiments in which the disclosure may be practiced. The terms “exemplary” and “example” used in this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

The previous description is provided to enable any person skilled in the art to practice the various aspects described herein. Various modifications to these example embodiments presented throughout this disclosure will be readily apparent to those skilled in the art. Thus, the claims are not intended to be limited to the example embodiments presented throughout the disclosure, but are to be accorded the full scope consistent with the language claims. All structural and functional equivalents to the elements of the example embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method for creating powder, the method comprising:
delivering a source material having a first material composition;
melting the source material to form a molten source material;
vibrating a substate structure, wherein the substrate structure includes a substrate material having a substrate material composition;
applying the molten source material to the vibrating substrate structure to obtain a powder, wherein a portion of the substrate material is selectively added to the molten source material such that the powder has a second material composition different than the first material composition; and
controlling the second material composition of the powder based on the first material composition and the substrate material composition.

2. The method of claim 1, wherein controlling the second material composition is further based on a grain structure of the substrate material.

3. The method of claim 1, wherein controlling the second material composition is further based on at least a delivery parameter of delivering the source material, a melt parameter of melting the source material, a vibration parameter of vibrating the substrate structure, or an application parameter of applying the molten source material.

4. The method of claim 3, wherein the delivery parameter includes at least a feed rate of the source material or a feed angle of the source material.

5. The method of claim 4, wherein the source material is in the form of a wire or a rod, and the delivery parameter includes at least the feed rate of the wire or the rod or the feed angle of the wire or the rod.

6. The method of claim 3, wherein the melting is performed by an energy beam or a plasma, and the melt parameter includes an energy of the energy beam or a temperature of the plasma.

7. The method of claim 3, wherein the vibration parameter includes at least an area of a vibrating surface of the substrate structure, a surface energy density of the substrate structure, a frequency of the vibrating, an amplitude of the vibrating, or a speed of the vibrating.

8. The method of claim 3, wherein the application parameter includes at least a density of the molten source material, a liquid velocity of the molten source material, a liquid flow rate of the molten source material, a liquid viscosity of the molten source material, or a surface tension of the molten source material.

9. The method of claim 1, wherein the second material composition includes the portion of the substrate material as a coating outside the powder.

10. The method of claim 1, wherein the second material composition includes the portion of the substrate material as a solute inside the powder.

11. The method of claim 1, wherein the first material composition includes a first element, and a composition of the substrate material includes the first element and a second element.

12. The method of claim 11, wherein controlling the second material composition is further based on a ratio of the second element to the first element in the composition of the substrate.

13. The method of claim 1, wherein the substrate material composition includes at least lithium, zinc, silver or magnesium.

14. The method of claim 1, wherein the substrate material composition includes aluminum.

15. The method of claim 14, wherein the substrate material composition further includes at least lithium, zinc, or magnesium.

16. The method of claim 1, wherein the first material composition includes at least copper or zirconium.

17. The method of claim 1, further comprising:
forming a base material on a bottom surface of the substrate structure.

18. The method of claim 17, wherein the base material includes a material configured to dissipate heat generated by the molten source material.

19. The method of claim 18, wherein the base material includes copper.

20. An apparatus for making powder, the apparatus comprising:
a substrate structure including a substate material having a substrate material composition;
a vibrating device configured to vibrate the substrate structure;
a heating device configured to melt a source material having a first material composition, wherein the source material forms a molten source material that is applied to the vibrating substrate structure to obtain a powder, wherein a portion of the substrate material is selectively added to the molten source material such that the powder has a second material composition different than the first material composition, and wherein the second material composition is controlled based on the first material composition and the substrate material composition; and
a delivering device configured to deliver the source material to the heating device.

21. The apparatus of claim 20, wherein the second material composition is further controlled based on a grain structure of the substrate material.

22. The apparatus of claim 20, further comprising:
a controller configured to control the second material composition further based on at least a delivery parameter of delivering device, a melt parameter of heating device, a vibration parameter of vibrating device, or an application parameter of the application of the molten source material to the vibrating substrate structure.

23. The apparatus of claim 22, wherein the delivery parameter includes at least a feed rate of the source material or a feed angle of the source material.

24. The apparatus of claim 23, wherein the source material is in the form of a wire or a rod, and the delivery parameter includes at least the feed rate of the wire or the rod or the feed angle of the wire or the rod.

25. The apparatus of claim 22, wherein the heating device is an energy beam or a plasma, and the melt parameter includes an energy of the energy beam or a temperature of the plasma.

26. The apparatus of claim 22, wherein the vibration parameter includes at least an area of a vibrating surface of the substrate structure, a surface energy density of the substrate structure, a frequency of the vibrating, an amplitude of the vibrating, or a speed of the vibrating.

27. The apparatus of claim 22, wherein the application parameter includes at least a density of the molten source material, a liquid velocity of the molten source material, a liquid flow rate of the molten source material, a liquid viscosity of the molten source material, or a surface tension of the molten source material.

28. The apparatus of claim 20, wherein the second material composition includes the portion of the substrate material as a coating outside the powder.

29. The apparatus of claim 20, wherein the second material composition includes the portion of the substrate material as a solute inside the powder.

30. The apparatus of claim 20, wherein the first material composition includes a first element, and a composition of the substrate material includes the first element and a second element.

31. The apparatus of claim 30, wherein the controller configured to control the second material composition is further based on a ratio of the second element to the first element in the composition of the substrate.

32. The apparatus of claim 20, wherein the substrate material composition includes at least lithium, zinc, silver or magnesium.

33. The apparatus of claim 20, wherein the substrate material composition includes aluminum.

34. The apparatus of claim 33, wherein the substrate material composition further includes at least lithium, zinc, or magnesium.

35. The apparatus of claim 20, wherein the first material composition includes at least copper or zirconium.

36. The apparatus of claim 20, further comprising:
a base material on a bottom surface of the substrate structure.

37. The apparatus of claim 36, wherein the base material includes a material configured to dissipate heat generated by the molten source material.

38. The apparatus of claim 37, wherein the base material includes copper.
